(19) United States
(12) Patent Application Publication
(10) Pub. No.: US 2003/0228517 A1
(43) Pub. Date: Dec. 11, 2003

(54) Electrochemical element with thin electrodes

(75) Inventors: Konrad Holl, Aalen-Dewangen (DE); Alfons Joas, Tannhausen (DE); Horst Wagner, Rosenberg (DE); Dejan Ilic, Ellwangen (DE); Roland Mueller, Herbolzheim (DE); Wolfgang Siefert, Ettenheim (DE)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: VARTA Microbattery GmbH. a corporation of Germany, Hannover (DE)

(21) Appl. No.: 10/425,385

(22) Filed: Apr. 29, 2003

(30) Foreign Application Priority Data
May 2, 2002 (DE) 102 19 424.6

(51) Int. Cl. H01M 2/02; H01M 2/30; H01M 2/08

(52) U.S. Cl. 429/162; 429/178; 429/176; 429/185

(57) ABSTRACT

An electrochemical element with thin electrodes in a housing formed from plastic sheets connected to one another. At least one of the plastic sheets is metallized in subareas on the side facing one of the electrodes. The metal layer forms an electrical contact with the electrode and forms an outer contact lug of the electrode. The plastic sheet may be a composite sheet with an inner metal sheet covered by a plastic sheet on both sides, and the metallization of the plastic sheet in the area outside the cell outline may be in the form of conductor tracks. In particular, the housing is formed from two plastic sheets which are sealed to one another and metallized on their side which points into the cell interior such that the metallization forms the electrical contact with the electrodes and forms the outer contact lugs of the electrodes and/or of the electrochemical element.

### RELATED APPLICATION

This application claims priority of German Patent Application No. 10219424.6 filed May 2, 2002.

### FIELD OF THE INVENTION

This invention relates to an electrochemical element with thin electrodes in a housing which is formed from plastic sheets that are sealed to one another.

### BACKGROUND

Electrochemical elements are known in widely different physical forms. In most cases, they have a mechanically robust housing and, for example, are in the form of round, button or prismatic cells. In these cells, a positive and a negative electrode, as well as a separator and the electrolyte, are arranged. The housings of electrochemical elements with alkaline electrolytes such as Zn/MnO₂ or Ni/MeH have a housing composed of steel or a stainless steel alloy. Their outer surfaces are generally nickel-plated to make better contact.

The housing is composed of stainless steel or aluminium, in the case of primary and secondary lithium cells, due to the higher electrode potential of up to 4.2 volts. Corrosion can thus be avoided which leads to passivation of the metal surfaces and to formation of higher contact resistances.

The contact pressure of the electrodes against the conductive container is generally sufficient as a contact, when the requirements for the current which can be drawn are not too high. When the requirements for the current are more severe, such as in the case of lithium cells, an additional contact is required in the form of metallic collectors within the electrodes. These collectors are linked to the housing by welding from output conductor lugs.

In addition to electrochemical elements with mechanically very robust housings, elements are also known which have sheet housings. Sheet housings such as these are used, for example, for so-called “lithium/polymer” and “lithium/ion” cells. These polymer cells have a housing composed of a composite sheet which consists, for example, of polyamide/aluminium/polypropylene. The use of these sheets results in a high degree of design flexibility, low weight and a high level of safety and reliability. The aluminium layer in these composite sheets in this case acts as a gas barrier.

The disadvantage of such composite sheets is that, in contrast to a metallic housing, the sheet is not electrically conductive. For this reason, output conductor lugs must be welded to the output conductor structures of the electrodes, and must be routed to the exterior.

Electrochemical elements of this type generally contain a cell stack which is formed from a large number of individual cells or individual elements. The individual element is a laminate produced from an output conductor, an active electrode film and a separator. Laminates such as these composed of firmly connected individual parts are produced, for example, as so-called “bicells.” Possible sequences comprise a negative electrode/separator/positive electrode/separator/negative electrode or a positive electrode/separator/negative electrode/separator/positive electrode.

A method for producing such lithium/ion batteries is described in U.S. Pat. No. 5,460,904. In this method, active materials and additives such as a conductivity enhancer in the electrodes or stabilizers in the separator, a specific copolymer, polyvinylidene difluoride hexafluoropropylene (PVDF-HFP) as well as proportions of a plasticizer, typically dibutyl phthalate (DBP) are intensively mixed, after the addition of acetone to dissolve the copolymer, and are extruded to form a sheet. The resulting electrode sheets and separator sheets are processed in two or more lamination processes to form bicells. Two or more bicells are placed one on top of the other to form a stack which, after insertion into a container composed, for example, of thermoformed aluminium composite sheet, filling with electrolyte, sealing with a cover, formation and end closure, is processed to form a complete battery.

The individual electrodes in such a case have output conductor structures in the form of a copper sheet for the negative electrode and in the form of aluminium for the positive electrode, which each have output conductor lugs. Two or more electrodes are connected in parallel via these output conductor lugs and passed through the housing from the composite assembly to make external contact. A large number of components are, therefore, required to make adequate contact with the individual electrodes, and the process of sealing the housing around these output conductor lugs is complex.

It would, therefore, be advantageous to provide a battery that can be produced easily and at low cost and in which, in particular, the process for making contact between the electrode and the outer output conductor is improved.

### SUMMARY OF THE INVENTION

The invention relates to an electrochemical element including a housing formed from a plurality of plastic sheets connected to one another, a plurality of electrodes positioned in the housing such that at least one of the plastic sheets has a side facing one of the electrodes, and a metal layer applied to at least a portion of the side and in contact with the electrode to form an electrical contact for the electrode outwardly of the electrochemical element.

### BRIEF DESCRIPTION OF THE DRAWINGS

The subject matter of the invention will be explained in more detail in the following text with reference to the Drawings.

FIG. 1 is a top plan view of an electrochemical element in accordance with aspects of the invention, with selected layers partially broken away for ease of understanding.

FIG. 2 is a sectional view taken along the line A-A of FIG. 1.

FIG. 3 is a sectional view of a further aspect of an electrochemical element according to the invention.

FIG. 4 shows, schematically, a perspective view of a configuration and individual parts of an electrochemical element according to aspects of the invention, broken apart for ease of understanding.

FIG. 5 shows a perspective view of an arrangement of additional conductor tracks in conjunction with an element according to aspects of the invention, broken apart for ease of understanding.

FIG. 6 shows a top plan view of an arrangement of metallized areas on a plastic composite strip according to aspects of the invention.

FIGS. 7a-7d show selected configurations of metallization on the plastic material or plastic composite material in accordance with aspects of the invention.

FIG. 8 shows, schematically, a perspective view of a preformed, thermoformed, plastic metal composite sheet with metallization according to aspects of the invention.

### DETAILED DESCRIPTION

It will be appreciated that the following description is intended to refer to specific embodiments of the invention selected for illustration in the drawings and is not intended to define or limit the invention, other than in the appended claims.

Since, according to aspects of the invention, the surface of a plastic sheet or of a plastic metal composite sheet which forms the cell housing, is partially metallized or comprises a metal layer, the cell structure can be considerably simplified. By appropriate shaping of the metallization or metal layer and internal connecting of the electrodes to this metallization, this structure can be used even for relatively high current loads, although it is particularly suitable for relatively low current loads.

It is advantageous that metallization of the plastic sheet, which forms the housing of the electrochemical element, can also be continued outside the actual cell housing in the form of conductor tracks.

The active cell components are arranged between two plastic sheets that are sealed to one another, in which case these plastic sheets may also be composite sheets with an inner metal layer, for example, an aluminium layer. Metallization on the side facing the electrode may be in form of a surface pattern or may be formed with interruptions in the metallization. The metallization can be reinforced in the area of the output conductor, which leads to the exterior, by applying an additional metal layer or by applying a further metal sheet. It is also possible not to seal the two plastic sheets which form the cell housing directly to one another, but to use a sealing frame or the like as an aid between the two sheets.

Furthermore, one of the plastic sheets or plastic metal composite sheets can be preformed by means of a thermoforming process. It is particularly advantageous to form the housing of the electrochemical element from two plastic sheets. These plastic sheets are sealed to one another and metallized on their side facing the cell interior such that the metallization forms the electrical contact with the electrodes and forms the outer contact lugs of the electrodes of the electrochemical element.

As shown in particular in FIG. 4, an electrochemical element according to aspects of the invention comprises a first plastic sheet 1, which is partially provided with a metal layer or metallization 2, and a second plastic sheet 7, which is likewise provided with a metal layer or metallization 8. The sheets 1 and 7 forming the housing may, thus, be plastic sheets. However, they are preferably plastic metal composite sheets with an inner aluminium layer, thus, providing a good water vapour barrier and a low gas diffusion rate. A composite sheet such as this comprises, for example, an outer polyamide layer 1a, 7a, a central aluminium layer 1b, 7b, and an inner polypropylene layer 1c, 7c, each of which are fitted with the metal layer matched to the shape of the electrode. The sheets may, for example, be partially metallized by means of a vacuum-deposited coating on the polypropylene side. The surface of the metal layer is in this case somewhat smaller than, or virtually the same size as, the electrodes 5 and 6.

The positive electrode 5 may, for example, be an MnO₂ or LiCoO₂ electrode, or a LiₓMnO₂ electrode. The negative electrode 6 may be composed of lithium metal, or a lithium metal alloy, or may be a lithium-intercalating graphite electrode. The separator 4 is, for example, a polypropylene film, a polyethylene film or a non-woven sheet composed of these materials.

After the arrangement of the semi-finished products as illustrated in FIG. 4 and the addition of an organic electrolyte, the composite sheets 1 and 7 are thermally sealed in a vacuum in the non-metallized sealing zone 10 and over the passage for the contacts, or are adhesively bonded to one another by means of a fusion adhesive 11, in the form of a sealing frame.

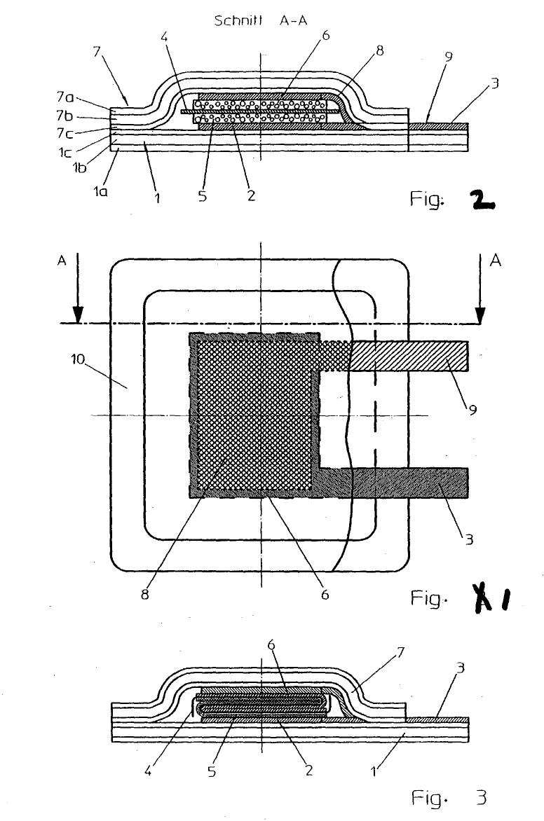

FIG. 2 shows a cross section through a complete cell. The output conductor lugs 3 and 9, which are connected to the respective metal layers 2 and 8, form the outer electrical output conductors of the cell, as can be seen from FIG. 1, which shows the same cell in a partially sectioned plan view.

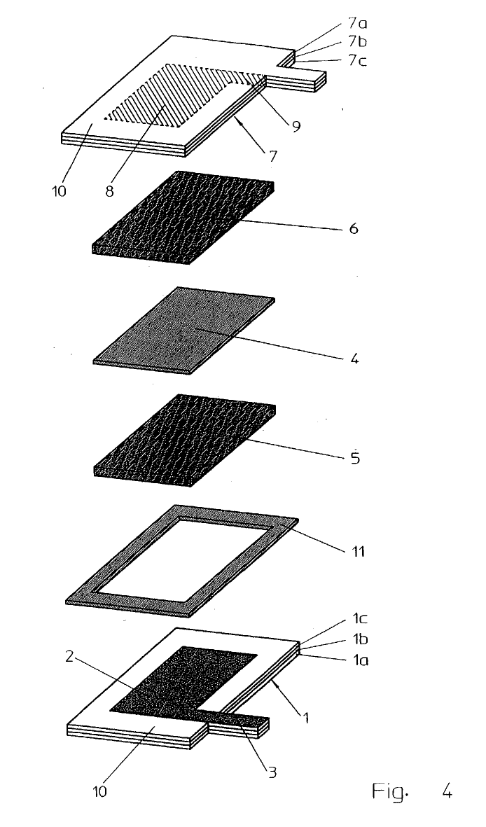

An embodiment of an electrochemical element as shown in FIG. 3 differs from the embodiment shown in FIG. 2 essentially in that a folded electrode pack is used which comprises a separator 4 between an anode 5 and a cathode 6.

It is particularly advantageous when using polymer electrodes, as previously explained, for these electrodes, which are composed, for example, of the active materials and PVDF as a binding agent, to be able to be laminated directly onto the metallized composite sheets, as a substrate. When using electrodes produced in this way in an arrangement as shown in FIG. 3, in which a folded electrode is used instead of a stack of electrodes, it is possible to load the cell with even higher currents.

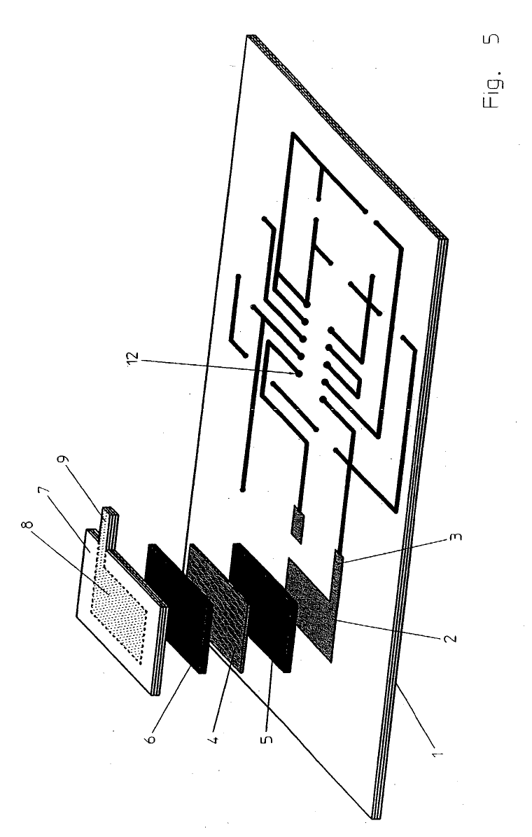

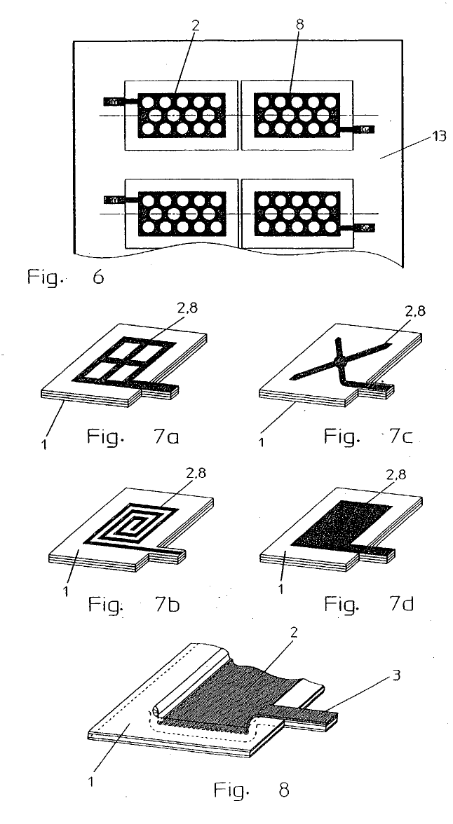

The metallization of or application of the metal layer to the sheets, which is carried out in selected areas, may be applied over a large area or in the form of a pattern, as can be seen from FIGS. 7a to 7d. FIG. 6 shows the arrangement of the metallized areas on a plastic composite strip 13, with the areas 2 in this case being metallized with aluminium, and the areas 8 with copper.

If the metal layer is not applied over the complete surface, then, when using electrodes which are applied to or laminated onto a metal sheet, this metal sheet can be connected by thermal sealing to the free, non-metallized areas of the plastic composite sheet. This causes the contact between the metal sheet output conductor of the electrode and the metal layer on the composite sheet to be improved.

As shown in FIG. 5, at least one of the plastic sheets or plastic metal composite sheets may at the same time be the substrate for conductor tracks 12 for further electronic components. This metal layer can be applied at the same time as the metal layer of the collector surface in the cell housing. The collector surfaces 2 and 8 and the conductor tracks 12 may be applied by means of vacuum deposition coating, by non-electrical or electrochemical metal deposition, or by printing by means of conductive pastes. The conductor tracks 12 and the collector surfaces 2 and 8, which can be applied by means of vacuum deposition coating, non-electrical or electrochemical metal deposition, can be produced in a directly structured manner by means of a mask technique. As an alternative, the metal layer may also be applied over the entire surface in each case, with the respective structure being produced by means of laser ablation or conventional photolithography in conjunction with a chemical etching technique, or plasma etching.

It is particularly advantageous to use a cell produced according to the invention in a so-called “smart card,” as described by way of example in German Patent Application 101 02 125.9, the subject matter of which is incorporated herein by reference. The metal layer which is arranged within the composite sheet may be formed from aluminium, copper or nickel as a vapour barrier or gas diffusion barrier. It may be particularly advantageous to increase the thickness of the output conductor lugs 3 and 9 by means of an additional metallization step, or to reinforce these areas with an additional metal sheet. The plastic sheet or plastic metal composite sheet can have a thickness of about 5 μm to 400 μm, in particular, a thickness of about 10 μm to about 150 μm. The metal layer applied to the composite sheet can have a thickness of about 0.02 μm to about 30 μm, preferably, a thickness of about 0.1 μm to about 5 μm.

It is particularly advantageous to preform at least one of the plastic or plastic metal composite sheets by means of a thermoforming process, such that a holder is produced for an electrode or for the electrode set with a separator, as illustrated in FIG. 8.

What is claimed is:

1. An electrochemical element comprising:
a housing formed from a plurality of plastic sheets connected to one another,
a plurality of electrodes positioned in the housing such that at least one of the plastic sheets has a side facing one of the electrodes, and
a metal layer applied to at least a portion of said side and in contact with the electrode to form an electrical contact for the electrode outwardly of the electrochemical element.

2. The electrochemical element according to claim 1, wherein the plastic sheets are sealed to one another.

3. The electrochemical element according to claim 1, wherein the plastic sheets are formed from a composite sheet with an inner metal sheet as a metal layer, wherein the inner metal sheet is covered by plastic sheets on both sides.

4. The electrochemical element according to claim 1, wherein the metal layer of the plastic sheet outside of the electrochemical element is in the form of conductor tracks.

5. The electrochemical element according to claim 1, wherein one side of one of the plastic sheets faces an interior portion of electrochemical element and wherein the one side is composed of a thermally sealable or adhesively bondable polymer.

6. The electrochemical element according to claim 1, wherein the metal layer is in the form of a surface pattern with interruptions therein.

7. The electrochemical element according to claim 1, wherein the metal layer is reinforced in an area of the electrical contact by applying an additional metal layer.

8. The electrochemical element according to claim 1, wherein the housing is formed from two plastic sheets sealed to one another and have sides oriented into an interior portion of the cell and metallized with the metal layer.

9. The electrochemical element according to claim 8, wherein the metal layer forms an electrical contact with the electrodes and forms outer contact lugs of the electrodes or of the electrochemical element.

10. The electrochemical element according to claim 1, wherein one of the plastic sheets has an area which is a non-metallized sealing surface, and a sealing frame is applied to an area of a sealing surface not covered by the metal layer.

11. The electrochemical element according to claim 1, wherein at least one of the plastic sheets is preformed by a thermoforming process.

12. The electrochemical element according to claim 1, wherein the plastic sheets have a thickness of about 5 μm to about 400 μm.

13. The electrochemical element according to claim 1, wherein the metal layer on the plastic sheets has a thickness of about 0.02 μm to about 30 μm.
